(19) United States
(12) Patent Application Publication
(10) Pub. No.: US 2010/0151557 A1
(43) Pub. Date: Jun. 17, 2010

(54) METHOD AND DEVICE FOR ESTABLISHING AN ORGANISM

(76) Inventors: Paul Griffin, Durham (GB); Brian V. Longhurst, Gloucester (GB)

Correspondence Address: Paul R. Martin, 5333 Bayridge Ct, Fairfield, CA, 94534, US

(21) Appl. No.: 12/733,126

(22) PCT Filed: Aug. 13, 2008
(86) PCT No.: PCT/US08/09655

§ 371 Date: Feb. 12, 2010

(30) Foreign Application Priority Data
Aug. 16, 2007 (GB) 0716011.2

(51) Int. Cl. C12N 1/20; A01G 9/02; C12M 1/00; C12N 1/14

(52) U.S. Cl. 435/252.1; 47/65.8; 47/66.7; 435/289.1; 435/254.1

(57) ABSTRACT

A method and device for establishing at least one plant in a first growing medium, comprising locating at least one device adjacent a first growing medium such that at least a portion of the or each said device is in contact with said first growing medium, the or each said device having a second growing medium contained within at least one substantially sealed bag, the or each bag having at least one first aperture and at least one second aperture therein, at least one of each of the first and second apertures being on substantially opposing sides of said bag.

### TECHNICAL FIELD AND INDUSTRIAL APPLICABILITY OF THE INVENTION

The present invention relates to a method and device for establishing an organism in a growing medium, and particularly, but not exclusively, to establishing a plant in a new growing medium, to altering the chemical or biological make up of an environment by establishing a new organism therein and to assist in the growth of an organism by removing a destructive other organism.

### BACKGROUND OF THE INVENTION

When introducing a new plant into a new environment one of the most important periods of time is that immediately after germination and through until the plant is sufficiently strong to grow without the aid of irrigation or chemical assistance from fertilisers and pesticides. When plants are being grown in hostile environments it is at this stage that the success or failure of the plant is often determined and factors such as drought may wipe out an entire crop. Furthermore where a food crop, for example a grain, is being grown, the period of establishment of this type of plant in a hostile environment forms a significant portion of the life of the plant from germination to harvest.

At present nutrients, pesticides and perhaps a water retaining medium, such as a super absorbent polymer, may be added to the growing medium, or soil, that a plant is being grown in. However, such usage of these chemicals is inefficient since the dosage used is not released in a controlled manner and is generally applied in excess so as to make sure there is sufficient, chemical present irrespective of losses to the environment. Furthermore, such losses may be considerable, for example at times of heavy rain a significant proportion of nutrients and of pesticides can be washed from the soil. This has the disadvantage that, for example, the nutrients are lost and unavailable to the plant which they were originally directed to and that such nutrients may lead to pollution such as eutrophication of water courses. In arid conditions loss of water is of particular significance since this is often a very significant determining factor in whether a plant is able to become established or that it dies. The introduction of a super absorbent polymer into the soil as described above, may assist in retaining water and making it available for a plant. However, once the plant has been harvested the super absorbent polymer remains in the soil. Furthermore, the amount of super absorbent polymer used is not controlled and may not be efficiently distributed within the soil so is to be most effective. For example, the best use of the polymer may be for it to be clumped around a plant or alternatively evenly distributed throughout the soil. It is very difficult to control the distribution of the polymer when it is undertaken by others, and therefore efficient and effective use of the polymer cannot be guaranteed.

There are a number of organisms capable of performing bio-remediation work on an environment. For example, some members of the family of bacteria Pseudomonas are capable of breaking down phenol into less harmful chemicals, which will then allow other plants to grow in a previously contaminated environment. The fungus Glomus Mosseae is capable of liberating phosphorus nutrients from rocks, thereby making the nutrients available for plants and allowing establishment of plants in a phosphorus poor environment. The establishment of these organisms in a suitable environment can prove difficult since, for example, the above mentioned bacteria although able to break down phenol can also be poisoned by it if it is present in too high a concentration. As a result it is not possible to simply apply such a bacteria on to a phenol contaminated site. Furthermore the bacteria may have other biological requirements not present in the contaminated environment and therefore may be unable to survive and colonise the site. Similarly the above mentioned fungus may have other biological requirements not met by the environment into which it is introduced and therefore may be unable to survive.

The use of pesticides to kill secondary organisms which attack the primary organism which is being grown in an environment is wide spread. However, such pesticide use tends to be single or intermittent doses applied in excess in order to entirely remove the secondary organism from the environment in the hope that it is unable to re-establish itself before a crop is harvested or a further dose of pesticide is applied. This excess dosing has the disadvantage that at such high doses other organisms may be affected by the pesticide even though they are not targeted, and losses to the environment may be significant. Furthermore, once the dose has been applied and for instance rain has washed the pesticide away the protection is lost and the plant, which may be able to take up the pesticide in order to protect itself, has no further pesticide available until a further dose is applied.

In certain situations it may be desirable to establish a particular type of native species of plant into a hostile environment. However when conditions are set up to assist such a species another species may intercede taking advantage of the improved condition but not providing the benefit of the initially desired species. For example, for habitat improvement purposes it may be desirable to establish an area of sand dunes with the appropriate native grasses providing support for the volume of sand forming the dune. When nutrients and other requirements are added to the sand to encourage such growth of sand dune grasses other plants (perhaps broad leaf plants) take advantage of the improved conditions. However, these plants may not produce a strong enough root structure and may be eroded away before a dune is produced.

### SUMMARY OF THE INVENTION

Preferred embodiments of the present invention seek to overcome the above described disadvantages of the prior art.

According to an aspect of the present invention there is provided a method for establishing at least one plant in a first growing medium, the method comprising the steps of:—

locating at least one device adjacent a first growing medium such that at least a portion of the or each said device is in contact with said first growing medium, the or each said device having a second growing medium contained within at least one substantially sealed bag, the or each bag having at least one first aperture and at least one second aperture therein, at least one of each of the first and second apertures being on substantially opposing sides of said bag.

According to another aspect of the present invention there is provided a device for establishing at least one plant in a first growing medium, the device comprising:—
at least one substantially sealed bag, the or each bag having at least one first aperture and at least one second aperture therein, at least one of each of the first and second apertures being on substantially opposing sides of said bag; and
second growing medium substantially contained within said bag.

By providing a bag containing a second growing medium, of the type described above and by locating such a bag adjacent a first growing medium, the advantage is provided that a plant which may not normally be able to establish itself in the first growing medium, or which would have considerable difficulties establishing itself in the first growing medium, is able to do so. In particular, the second growing medium is able to support the plant as a seedling by providing the ideal balance of nutrients, a controlled and contained water supply, a balance of appropriate pesticides for the environment in which it is located and an ideal growing matrix for supporting the seedling plant. By using a bag the advantage is provided that water entering the bag may be contained therein and is less prone to evaporation and the bag also insulates the first growing medium immediately below it from evaporation thereby encouraging the roots of the plant through the aperture in the bag and into the first growing medium.

In a preferred embodiment said bag comprises at least one sheet.

The or each sheet may comprise a plurality of layers.

The or each sheet may also comprise one or more layers selected from the following:—
hydrophilic waterproof polymer;
iron oxide doped acrylic;
cavitated polypropylene;
substantially black ink;
polyethylene; or
water retaining material.

By providing the bag with a layer of hydrophilic waterproof polymer, water encountering the layer will be assisted to travel to the apertures where entering the bag it will be retained around the extremities encouraging the roots to head towards these extremities and therefore towards the first growing medium adjacent the lower surface of the bag.

In a preferred embodiment, the water retaining material comprises at least one super absorbent polymer.

The at least one super absorbent polymer may comprise cross-linked polyacrylamide.

By providing the bag with a layer of super absorbent polymer, water entering the bag will be retained around the extremities encouraging the roots to head towards these extremities and therefore towards the first growing medium adjacent the lower surface of the bag.

In a preferred embodiment said device is adapted to be placed on a substantially planar surface of said first growing medium such that at least one of said first or second apertures are in contact with said surface irrespective of the orientation at which said device is placed.

By providing the device with first and second apertures arranged such that the orientation of the device does not effect the likelihood of establishment of the plant, provides the advantage that such devices can be easily distributed, for instance thrown from the back of a moving vehicle, and that unskilled persons may use the device without effecting its likelihood of the success.

The or each sheet may be perforated with said first and second apertures.

In a preferred embodiment said apertures are substantially equidistant from each other.

The first aperture may comprise at least one slit or may comprise two intersecting slits substantially perpendicular to each other.

By forming the first aperture as a pair of intersecting perpendicular slits the advantage is provided that the potential size of the first aperture is large in that if the four triangular portions adjacent the slits of the first aperture are folded back a large approximately square space is exposed allowing the plant to grow through first aperture with ease. At the same time, when the portions adjacent the slits are folded down the sheet appears almost whole and the losses of water due to evaporation through the slits are minimal. Furthermore, when rain water lands on the triangular portions adjacent the two slits the water will tend towards the slits and enter the bag.

The second growing medium may comprise at least one plant supporting part.

In a preferred embodiment, said plant supporting part comprises exfoliated mica.

By including a plant supporting part, in the form of exfoliated mica, in the second growing medium, the plant is provided with an ideal growing matrix for its seedling stage.

In a preferred embodiment, said second growing medium may comprise at least one aeration part, exfoliated mica for example, to maintain air filled porosity within the bag.

By including an aeration part the structure of the said second growing medium is kept open to allow correct gas exchange within the root zone.

In a preferred embodiment, said second growing medium may comprise at least one water retaining part.

In another preferred embodiment, said water retaining part comprises at least one super absorbent polymer.

In a further preferred embodiment, said at least one super absorbent polymer comprises cross-linked polyacrylamide.

By providing the second growing medium with a water retaining part in the form of a super absorbent polymer, for example cross linked polyacrylamide, the advantage is provided that in arid conditions the polymer is able to absorb large quantities of water, relative to that absorbed by the first growing medium, and make this available to the plant over an extended period of time. In particular this will be available for a longer period of time than the first growing medium is able to manage.

In a preferred embodiment, said second growing medium comprising at least one nutrient part.

The nutrient part may comprise at least one controlled release fertiliser.

By including a nutrient, in particular a controlled release fertiliser, in the second growing medium the advantage is provided that an ideal balance of nutrients can be provided to the plant and specifically these nutrients can be tailored to a plant in its seedling form prior to full establishment in the first growing medium.

In a preferred embodiment, said second growing medium may comprise at least one water retaining and nutrient part.

In another preferred embodiment, said water retaining and nutrient part comprises at least one super absorbent polymer coated controlled release fertiliser.

The second growing medium may further comprise at least one pesticide.

By providing the second growing medium with one or more pesticides, the advantage is provided that the plant can be protected from known pests and in particular those which the plant is prone to attack from in its seedling stage.

In a preferred embodiment, said second growing medium may comprise at least one symbiotic plant organism.

By providing a symbiotic plant organism, the advantage is provided this organism can provide additional protection and/or other assistance to the plant as it develops.

The device may further comprise at least one organism at least partially contained in said second growing medium.

The second growing medium may further comprise at least one seed or seedling of a plant to be grown.

By locating a seed in the second growing medium the advantage is provided that the device may be stored prior to locating adjacent the first growing medium. By providing one or more seeds and/or more seedlings in the second growing medium the advantage is provided that the device can be tailored specifically to the number of plants to be grown in the device. Thus an untrained person will not overload the device with more plants than the second growing medium is capable of supporting.

According to another aspect of the present invention there is provided a device for at least partial removal of at least one substance from a first growing medium, the device comprising:—
at least one sheet, the or each sheet being adapted to define at least one volume, at least one said sheet having a plurality of apertures therein, extending substantially over an external surface of said volume;
second growing medium substantially contained within said volume; and
at least one first organism adapted to at least partially remove at least one ingredient from said first growing medium;
wherein said device is adapted to partially engage a surface of a first growing medium such that at least one of said apertures is engaged with said first growing medium.

By providing a first organism contained within a device as described above, the advantage is provided that the first organism, which is capable of removing an ingredient from the first growing medium, is protected within the second growing medium and is therefore able to colonise the first growing medium from the device. This has the advantage that where the first growing medium may be a hostile environment for the first organism and the device provides a set of conditions, in the second growing medium, which are ideal for the first organism and can therefore maintain the first organism whilst it establishes itself in the first growing medium. For example one of the above mentioned bacteria Pseudomonas Putida, which is capable of breaking down phenol, may not be able to establish itself in the first growing medium if the concentration of phenol there in is to high. By being initially contained within the device the bacteria can make small inroads into the concentration of phenol and once a small volume of the first growing medium has the concentration of phenol reduced or removed, the bacteria are able to begin colonising the first growing medium. Furthermore if the conditions within the first growing medium alter significantly such that the bacteria may be destroyed, for example a significant shift in temperature, the device may provide a protection for the bacteria and allow them to begin colonising the first growing medium again without the need for their reintroduction.

In a preferred embodiment, the or each sheet comprises one or more layers selected from the following:—
hydrophilic waterproof polymer;
iron oxide doped acrylic;
cavitated polypropylene;
substantially black ink;
polyethylene; or
water retaining material.

The water retaining material may comprise at least one super absorbent polymer.

In a preferred embodiment, said at least one super absorbent polymer comprises cross-linked polyacrylamide.

The or each sheet may be sealed to itself or a further sheet adjacent its edges so as to define said volume in the form of a bag.

The or each sheet may be substantially rigid and defines a fixed volume.

The fixed volume may be substantially tubular.

In a preferred embodiment, said device is adapted to be placed on a substantially planar surface of said first growing medium such that at least one of said apertures is in contact with said surface irrespective of the orientation at which said device is placed.

In another preferred embodiment, said apertures are substantially equidistant from each other.

The second growing medium may comprise at least one nutrient for said first organism.

In a preferred embodiment, said removal is by chemically altering said ingredient.

In a preferred embodiment, if said ingredient is a second organism, said removal is by biologically altering second organism.

Said first organism may be a fungus or a bacteria.

According to another aspect of the present invention there is provided a device for assisting in the growth of at least one first organism, the device comprising:—
at least one sheet, the or each sheet being adapted to define at least one volume, at least one said sheet having a plurality of apertures therein, extending substantially over an external surface of said volume;
at least one active ingredient, contained within said volume, said ingredient is adapted to kill or slow the rate of growth of a second organism, said second organism being detrimental to the growth of said first organism, wherein said first organism is able to access to said ingredient in order to protect itself from said second organism.

By providing a device to assist the growth of a first organism by containing an ingredient adapted to kill or slow the rate of growth of a second organism within the device, the advantage is provided that a second organism can be destroyed there by protecting the first species. In particular the device can contain growing conditions suitable for the second organism except that it may also contain a pesticide or other suitable means for destroying that organism. This has the advantage that as the first organism spreads towards the device and colonises it the pesticide can be passed back to the preceding first organisms. Furthermore, the second organisms may also be able to tap into the device to absorb the pesticide and be able to protect itself. The further advantage is provided that, unlike a blanket application of a single dose of the pesticide to the first species the release of the pesticide is controlled and the overall dosage can be lower since it is not necessary to entirely wipe out the first organism in the hope of preventing its return until the next application of the pesticide. Furthermore, as the second organism will be able to continually protect itself by accessing the ingredient the need to destroy all of the second organism is reduced and therefore the dosage can be reduced. Furthermore, the detrimental effects of a single large dose of pesticide being washed away are different those of the long term application of small doses seeping from the device, which may be absorbed and broken down in the environment.

According to a further aspect of the present invention there is provided a device for assisting in the growth of at least one first organism, the device comprising:—
at least one sheet, the or each sheet being adapted to define at least one volume, at least one said sheet having a plurality of apertures therein, extending substantially over an external surface of said volume;
at least one first and at least one second active ingredients, contained within said volume, wherein said first ingredient is adapted to provide nutrients and/or water to assist in the growth of said first organism, and said second ingredient being adapted to kill or reduce the rate of growth of a second organism.

By providing a device of the type described above, in which a first and second ingredient are provided the first ingredient assisting the growth of a first species and the second ingredient preventing or reducing the growth of the second species, the advantage is provided that the device is able to selectively assist the establishment of native species in a first growing medium. If the device is provided with a second growing medium containing an ideal balance of nutrients for the first species and selective pesticides against a second species the first species will be at a considerable advantage and more able to establish itself. For example in many environments hardy grasses are able to establish themselves easily whereas more delicate broad leaf plants may have considerable difficulties. If the device is provided with ideal conditions for a broad leaf plant and a selective pesticides aimed at grasses the device will encourage the growth of broad leaf plants and discourage the grasses which may be regarded as weeds.

In a preferred embodiment, the or each sheet comprises one or more layers selected from the following:—
hydrophilic waterproof polymer;
iron oxide doped acrylic;
cavitated polypropylene;
substantially black ink;
polyethylene; or
water retaining material.

The water retaining material may comprise at least one super absorbent polymer.

In a preferred embodiment, said at least one super absorbent polymer comprises cross-linked polyacrylamide.

The or each sheet may be sealed to itself or a further sheet adjacent its edges so as to define said volume in the form of a bag.

In a preferred embodiment, the or each sheet is substantially rigid and defines a fixed volume.

In another preferred embodiment, said fixed volume is substantially tubular.

The device may be adapted to be placed on a substantially planar surface of a first growing medium such that at least one of said apertures is in contact with said surface irrespective of the orientation at which said device is placed.

The device may further comprise second growing medium contained within said volume.

In a preferred embodiment, said second growing medium comprises at least one plant supporting part.

Said plant supporting part may comprise exfoliated mica.

The second growing medium may comprise at least one water retaining part.

In a preferred embodiment, said water retaining part comprises at least one super absorbent polymer.

In another preferred embodiment, said at least one super absorbent polymer comprises cross-linked polyacrylamide.

The nutrient may comprise at least one controlled release fertiliser.

The second growing medium may comprise at least one water retaining and nutrient part.

In a preferred embodiment, said water retaining and nutrient part comprises at least one super absorbent polymer coated controlled release fertiliser.

The second growing medium may further comprise at least one pesticide.

The second growing medium may also further comprise at least one symbiotic plant organism.

The device may further comprise at least one organism at least partially contained in a second growing medium.

According to another aspect of the present invention there is provided a method for establishing at least one organism in a first growing medium, the method comprising the steps of:—

locating at least one device adjacent a first growing medium such that at least a portion of the or each said device is in contact with said first growing medium, the or each said device having a second growing medium contained within a volume defined by at least one sheet, the or each sheet having at least one first aperture and at least one second aperture therein, at least one of each of the first and second apertures being on substantially opposing sides of said volume.

According to a further aspect of the present invention there is provided a device for establishing at least one organism in a first growing medium, the device comprising:—
at least one sheet, the or each sheet being adapted to define at least one volume, at least one said sheet having at least one first aperture and at least one second aperture therein, at least one of each of the first and second apertures being on substantially opposing sides of said volume; and
second growing medium substantially contained within said volume.

The or each sheet may comprise a plurality of layers.

The or each sheet may comprise at least one layer of iron oxide doped acrylic.

The or each sheet may comprise at least one layer of cavitated polypropylene.

The or each sheet may comprise at least one layer of substantially black ink.

The or each sheet may comprise at least one layer of polyethylene.

The or each sheet may comprise at least one layer of water retaining material.

The water retaining material may comprise at least one super absorbent polymer.

The at least one super absorbent polymer may comprise cross-linked polyacrylamide.

The or each sheet may sealed to itself or a further sheet adjacent its edges so as to define said volume in the form of a bag.

The or each sheet may be substantially rigid and defines a fixed volume, and said fixed volume may substantially tubular.

In a preferred embodiment, said device is adapted to be placed on a substantially planar surface of said first growing medium such that at least one of said first or second apertures are in contact with said surface irrespective of the orientation at which said device is placed.

In another preferred embodiment, the said or each sheet is perforated with said first and second apertures.

In a preferred embodiment, said apertures are substantially equidistant from each other.

The first aperture may comprise at least one slit and preferably two intersecting slits substantially perpendicular to each other.

In a preferred embodiment, said second growing medium comprises at least one plant supporting part.

In another preferred embodiment, said plant supporting part comprises exfoliated mica.

In a preferred embodiment, said second growing medium comprises at least one water retaining part.

In another preferred embodiment, said water retaining part comprises at least one super absorbent polymer.

In a further preferred embodiment, said at least one super absorbent polymer comprises cross-linked polyacrylamide.

Said second growing medium may comprise at least one nutrient part.

Said nutrient part may comprise at least one controlled release fertiliser.

The second growing medium may further comprise at least one water retaining and nutrient part.

In a preferred embodiment, said water retaining and nutrient part comprises at least one super absorbent polymer coated controlled release fertiliser.

Said second growing medium may also comprise at least one pesticide.

Said second growing medium may further comprise at least one symbiotic plant organism.

The device may further comprise at least one organism at least partially contained in a second growing medium.

The second growing medium may further comprise at least one seed or seedling of a plant to be grown.

The second growing medium may comprise at least one biological agent of change.

In a preferred embodiment, the or each said biological agent of change is adapted to at least partially remove at least one ingredient from said first growing medium.

Said removal may be by chemically altering said ingredient.

Said ingredient may be a biologically active ingredient and said removal may be by biologically altering said ingredient.

Said removal may be by killing said biologically active ingredient.

Said biological agent of change may be a fungus or a bacteria.

### BRIEF DESCRIPTION OF THE FIGURES

Preferred embodiments of the present invention will now be described, by way of example only, and not in any limititive sense, with reference to the accompanying drawings, of which:—

FIG. 1 shows a schematic sectional view of a device of an aspect of the present invention;

FIG. 2 shows a schematic view of a section of the sheet of the device of FIG. 1;

FIG. 3 shows a schematic sectional view of a sheet of an upper portion of the device of FIG. 1;

FIG. 4 shows a plan view a device of FIG. 1;

FIG. 5 shows a schematic sectional view of a portion of a sheet of an underside of the device of FIG. 1;

FIG. 6 shows an underneath view of the device of FIG. 1;

FIG. 7 shows a schematic view of the device of FIG. 1 in use; and

FIG. 8 shows a schematic sectional view of a device of another aspect of the present invention in use.

### DESCRIPTION OF THE INVENTION

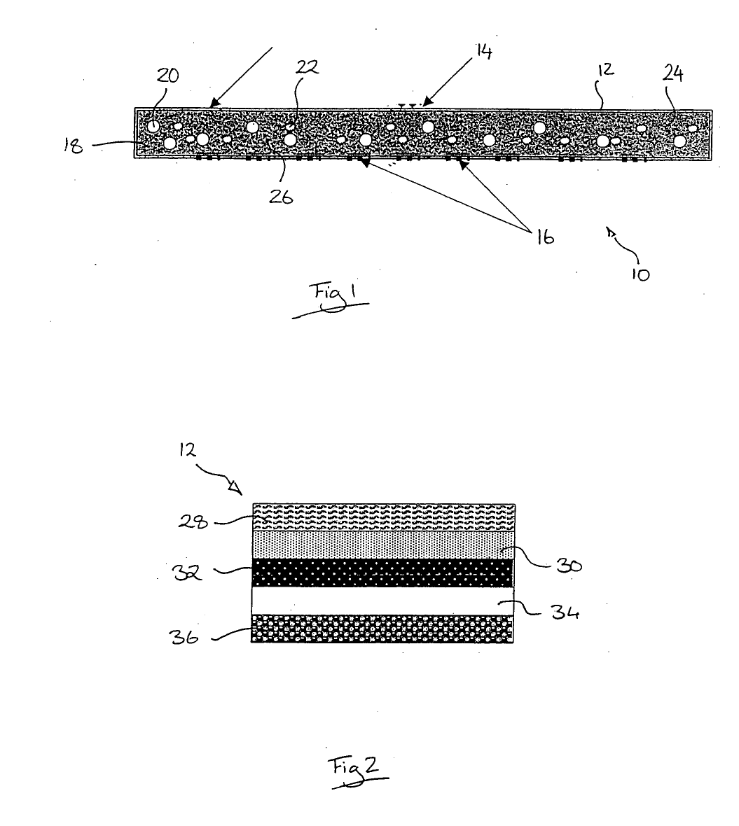

Referring to FIG. 1, a device 10 for establishing at least one organism (not shown) has at least one sheet 12, defining a volume and having at least one first aperture 14 and at least one second aperture 16 therein. The volume defined by sheet 12 contains a second growing medium 18 itself comprising nutrient, in the form of controlled release fertiliser granules 20, a water retaining part, in the form of a super absorbent polymer, specifically cross linked polyacrylamide 22. The second growing medium 18 also has a plant supporting part, in the form exfoliated mica mineral 24 and may contain symbiotic plant organisms 26.

Referring to FIG. 2, sheet 12 is formed from layers of iron oxide doped acrylic 28, cavitated polypropylene 30, black ink 32, polyethylene 34 and super absorbent polymer dosed with fertiliser or containing granules of controlled release fertiliser 36. Iron oxide doped acrylic layer 28 is provided to inhibit degradation of the lower layers of the device and the components of the second growing medium 18 from ultra violet light. Cavitated polypropylene layer 30 diffuses light input, black ink layer 32 acts as a black out to the inside of device 10. Polypropylene layer 34 provide a water barrier preventing evaporation from within device 10 and also allows the super absorbent polymer in layer 36 to be bonded to and form part of sheet 12. The air pockets in the cavitated polypropylene layer 30 diffuse any direct sunlight hitting the device 10 and the ink layer 32 blocks light from passing through sheet 12. As a result the only light entering device 10 is through first apertures 14, and thus seedling plants will tend to grow in the direction of this aperture 14 allowing them easiest access out of the device 10.

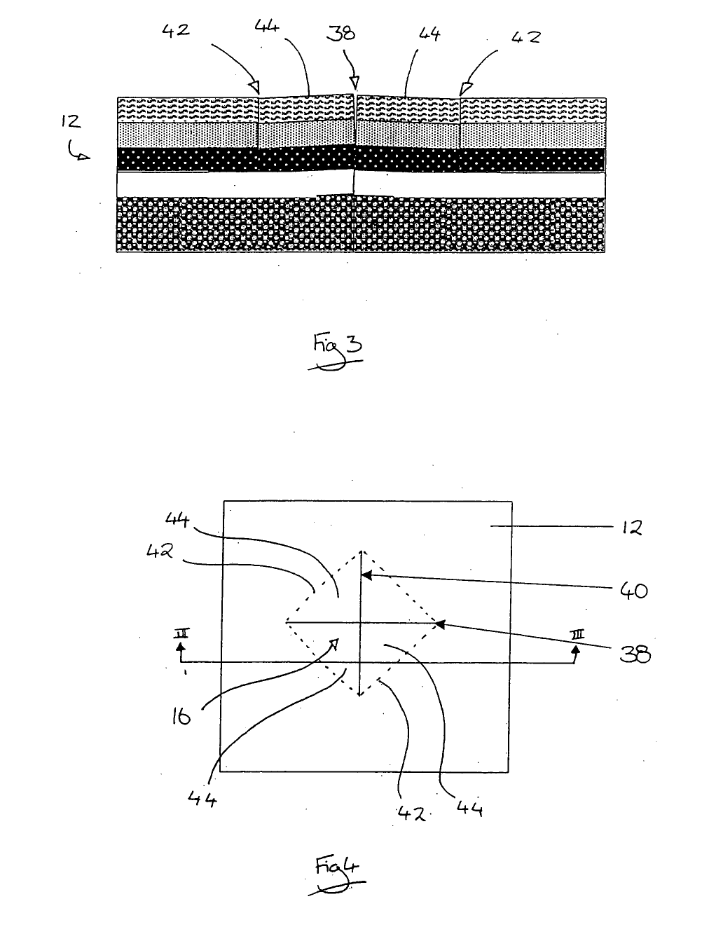

Referring to FIGS. 3 and 4, on the upper-side of device 10 sheet 12 has a first aperture 16 defined by slits 38 and 40 which are arranged at right angles to each other. Along with crease lines 42 these slits 38 and 40 define triangular flaps 44.

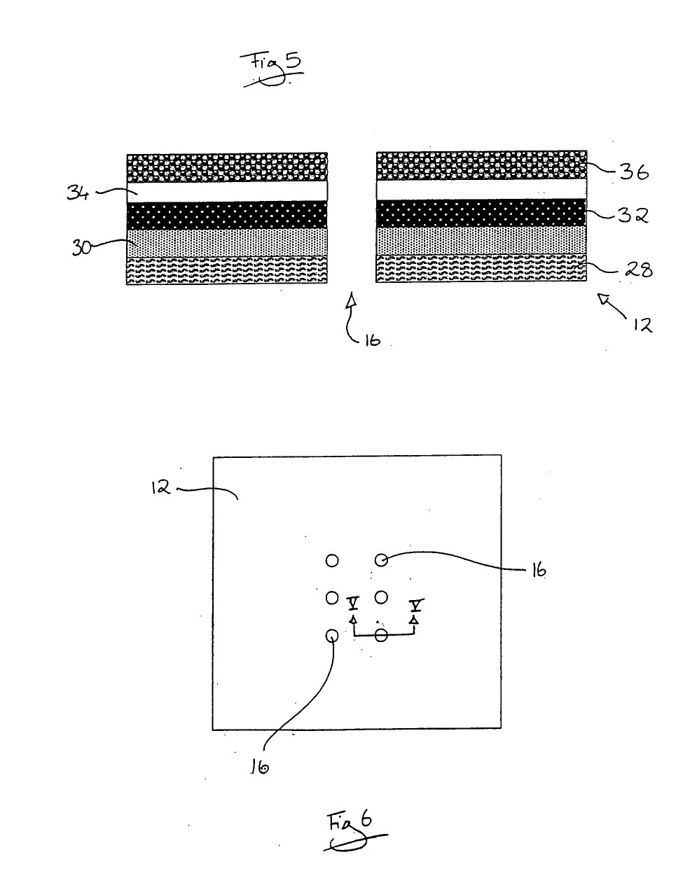

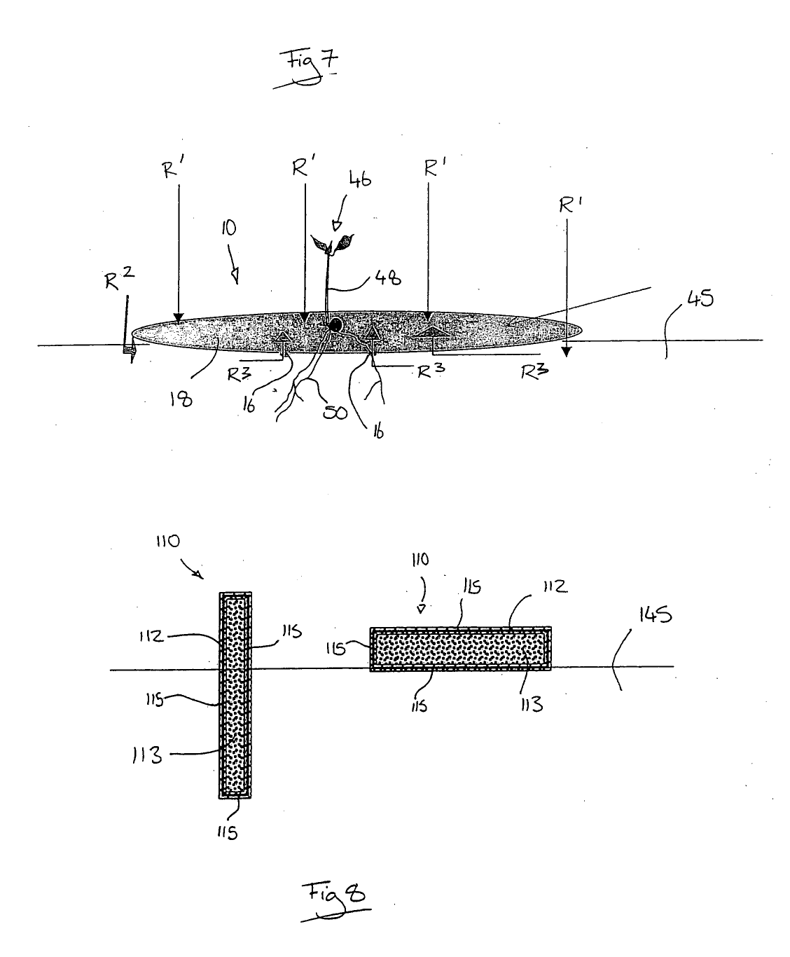

Referring FIGS. 5 and 6, sheet 12 has second apertures 16 located in its underside. Referring to FIG. 7, device 10 is located on first growing medium 45 and has plant 46 consisting of stem 48 and roots 50 growing therein. FIG. 7 also shows direction R¹ in which rain falls onto device 10. Water running off device 10 may enter the ground in direction R² and water may be taken up into device 10 in direction R³.

Referring to FIG. 8, in which parts in common with the above embodiment are denoted with like reference numerals increased by 100, device 110 is moulded so is to form sheets 112 which define a volume 113. Sheet 112 has apertures 115 therein.

Referring to FIGS. 1 to 7, device 10 is placed on first growing medium 45 such that second apertures 16 are in contact with first growing medium 45. Plant 46 is able to push through slits 38 and 40 of first aperture 16 whilst roots 50 are able to extend through second apertures 16. When rain falls in direction R¹ if it lands on flaps 44 it is likely to trickle down and enter device 10 through aperture 16. Any rain falling on device 10 and not entering through aperture 16 will tend to run off device 10 in direction R² and into first growing medium 45. Super absorbent polymer 22 will tend to draw this rain water in direction R³ into device 10 which then allows further water to be absorbed in the first growing medium 45 immediately adjacent the device 10. Device 10 also provides a layer of insulation decreasing the likelihood of evaporation of the rain water from immediately below itself.

As plant 46 begins to become established roots 50 extend through apertures 16 into first growing medium 45 and are able to utilise water and nutrients in first growing medium 45. If plant 46 is a grain which is harvested, when such harvesting has occurred the device may be removed from the soil. Device 10 may also be placed just below the surface of first growing medium 45 and in order to assist removal of device 10 from such a location the device may be formed into strips of grouped devices linked together or a single elongate device having a plurality of first apertures 14 in sheet 12 and a plurality of plants 46 growing therein.

Referring to FIG. 8 a device 110 may be placed on the surface of a first growing medium 145 or located at least partially within growing medium 145. Volume 113 contains at least one first organism adapted to remove or reduce the concentration of at least one ingredient of the first growing medium 145. For example the bacteria Pseudomonas Putida is able to break down phenol which may be a pollutant in first growing medium 145. From within the device 110 the bacteria are able to proliferate and extend from device 110 through apertures 115.

Alternatively the fungus Glomus Mosseae may be contained within device 110 and in a similar manner extend through apertures 115 into the first growing medium 145. This fungus is able to produce phosphorus containing chemicals from rocks and therefore may increase the nutrients available within first growing medium 145 making the growing medium 145 suitable for growing other organisms such as plants.

Alternatively the device 110 may contain a pesticide used to kill the fungus Botrytis which tends to affect young tomato plants. The device 110 contains a pesticide as well as otherwise ideal growing conditions for this fungus. As a result the fungus is attracted to grow in the device 110 but destroyed by the pesticide. The pesticide is then able to pass into other fungal growths immediately adjacent that which has been destroyed. Furthermore, the device is able to slowly release the pesticide through apertures 115 into the first growing medium 145 where it is also able to destroy the fungus. Furthermore, a plant (not shown) is also able to tap into the device 110 and obtain nutrients and water which may be contained therein but also has access to the pesticide thereby increasing its own protection against the fungus.

Alternatively the device may contain ideal growing conditions for a first organism and a selective pesticide preventing the growth of a second organism. For example, the device may contain ideal growing conditions for a broad leaf plant but also contain a pesticide selectively active on grasses. As a result, a seed of an indigenous broad leaf plant which settles in or adjacent device 110 is provided with ideal growing conditions and is therefore likely to be established in first growing medium 145 whereas a grass seed will be prevented from growing and therefore less likely to establish itself.

It will be appreciated by persons skilled in the art the above embodiments have been described by way of example only, and not of any imitative sense, and that there is alterations and modifications are possible without departure from the scope of the invention as defined by the appended claims. For example, the sheet or sheets 12 that define the volume may be formed by moulding to define the volume rather folded and sealed. Furthermore the sheet material could include a layer of hydrophilic waterproof polymer to assist in directing water towards the apertures.

1. (canceled)

2. A device for establishing at least one plant in a first growing medium, the device comprising:—
at least one substantially sealed bag, the or each bag having at least one first aperture and at least one second aperture therein, at least one of each of the first and second apertures being on substantially opposing sides of said bag; and
second growing medium substantially contained within said bag.

3. A according to claim 2, wherein the bag comprises at least one sheet having a plurality of layers.

4. (canceled)

5. A device according to claim 2, wherein the sheet comprises at least one layer selected from the following:—
hydrophilic waterproof polymer;
iron oxide doped acrylic;
cavitated polypropylene;
substantially black ink;
polyethylene; or
water retaining material.

6. A device according to claim 5, wherein said water retaining material comprises at least one super absorbent polymer.

7. A device according to claim 6, wherein said at least one super absorbent polymer comprises cross-linked polyacrylamide.

8-11. (canceled)

12. A device according to claim 2, said first aperture comprising two intersecting slits substantially perpendicular to each other.

13. A device according to claim 2, said second growing medium comprising at least one plant supporting part.

14. A device according to claim 13, wherein said plant supporting part comprises exfoliated mica.

15. A device according to claim 2, said second growing medium comprising at least one water retaining part.

16. A device according to claim 15, wherein said water retaining part comprises at least one super absorbent polymer.

17. A device according to claim 16, wherein said at least one super absorbent polymer comprises cross-linked polyacrylamide.

18. A device according to claim 2, said second growing medium comprising at least one nutrient part.

19. A device according to claim 18, wherein said nutrient part comprises at least one controlled release fertiliser.

20. A device according to claim 2, said second growing medium comprising at least one water retaining and nutrient part.

21. A device according to claim 20, wherein said water retaining and nutrient part comprises at least one super absorbent polymer coated controlled release fertiliser.

22. A device according to claim 2, said second growing medium comprising at least one pesticide.

23. A device according to claim 2, said second growing medium comprising at least one symbiotic plant organism.

24. A device according to claim 2, the device further comprising at least one organism at least partially contained in said second growing medium.

25. A device according to claim 2, said second growing medium comprising at least one seed of a plant to be grown.

26. (canceled)

27. A device for at least partial removal of at least one substance from a first growing medium, the device comprising:—
at least one sheet, the or each sheet being adapted to define at least one volume, at least one said sheet having a plurality of apertures therein, extending substantially over an external surface of said volume;
second growing medium substantially contained within said volume; and
at least one first organism adapted to at least partially remove at least one ingredient from said first growing medium;
wherein said device is adapted to partially engage a surface of a first growing medium such that at least one of said apertures is engaged with said first growing medium.

28-36. (canceled)

37. A device according to claim 27, further including a chemical for chemically altering said ingredient.

38. A device according to claim 27 further including a second organism which includes a means for biologically altering second organism.

39. A device according to claim 27, wherein said first organism is a fungus.

40. A device according to claim 27, wherein said first organism is a bacteria.

41. (canceled)

42. A device for assisting in the growth of at least one first organism, the device comprising:—
at least one sheet, the or each sheet being adapted to define at least one volume, at least one said sheet having a plurality of apertures therein, extending substantially over an external surface of said volume;
at least one active ingredient, contained within said volume, said ingredient is adapted to kill or slow the rate of growth of a second organism, said second organism being detrimental to the growth of said first organism, wherein said first organism is able to access to said ingredient in order to protect itself from said second organism.

43-62. (canceled)

63. (canceled)

64-66. (canceled)

67. A device according to claim 2, wherein at least one of the opposing sides of the bag comprises at least one layer of iron oxide doped acrylic.

68. A device according to claim 2 wherein, at least one of the opposing sides of the bag comprises at least one layer of cavitated polypropylene.

69. A device according to claim 2 wherein at least one of the opposing sides of the bag comprises at least one layer of substantially black ink.

70. A device according to claim 2 wherein at least one of the opposing sides of the bag comprises at least one layer of polyethylene.

71. A device according to claim 2, wherein at least one of the opposing sides of the bag comprises at least one layer of water retaining material.

72. A device according to claim 71, wherein said water retaining material comprises at least one super absorbent polymer.

73-99. (canceled)

100. A device according to claim 2, wherein said biological agent of change is a fungus.

101. A device according to claim 2, wherein said biological agent of change is a bacteria.

102. (canceled)

103. (canceled)

104. A method for establishing at least one plant in a first growing medium, the device comprising:—
locating at least one device adjacent a first growing medium such that at least a portion of the or each said device is in contact with said first growing medium, the or each said device having a second growing medium contained within at least one substantially sealed bag, the or each bag having at least one first aperture and at least one second aperture therein, at least one of each of the first and second apertures being on substantially opposing sides of said bag.

105. A method for establishing at least one organism in a first growing medium, the method comprising the steps of:—
locating at least one device adjacent a first growing medium such that at least a portion of the or each said device is in contact with said first growing medium, the or each said device having a second growing medium contained within a volume defined by at least one sheet, the or each sheet having at least one first aperture and at least one second aperture therein, at least one of each of the first and second apertures being on substantially opposing sides of said volume.
